(19) United States
(12) Patent Application Publication
(10) Pub. No.: US 2009/0091505 A1
(43) Pub. Date: Apr. 9, 2009

(54) Antenna device with a single-loop radiating element

(75) Inventors: Tiao-Hsing Tsai, Yungho City (TW); Chao-Hsu Wu, Lu Chu Hsiang (TW); Chi-Yin Fang, Pingtung City (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Quanta Computer Inc.

(21) Appl. No.: 12/072,797

(22) Filed: Feb. 28, 2008

(30) Foreign Application Priority Data
Oct. 9, 2007 (TW) 096137818

(51) Int. Cl. H01Q 9/04; H01Q 11/12

(52) U.S. Cl. 343/741; 343/700 MS

(57) ABSTRACT

An antenna device includes a single-loop radiating element, a radiating arm, a feeding element, and a grounding element. The single-loop radiating element is operable within a first frequency band. The radiating arm extends from the single-loop radiating element and is operable in second frequency band. The feeding element is connected to the single-loop radiating element and the radiating arm. The grounding element is connected to the single-loop radiating element.

### CROSS-REFERENCE TO RELATED APPLICATION

This application claims priority of Taiwanese application no. 096137818, filed on Oct. 9, 2007.

### BACKGROUND OF THE INVENTION

1. Field of the Invention

This invention relates to an antenna device, more particularly to an antenna device that includes a single-loop radiating element.

2. Description of the Related Art

FIG. 1 illustrates a conventional dual-band planar inverted-F antenna (PIFA) 1 that includes a parasitic element (not shown) or a coupling element (not shown).

Although the conventional dual-band PIFA 1 achieves its intended purpose, the conventional dual-band PIFA 1 has an insufficient bandwidth.

In U.S. Pat. No. 6,714,162, there has been proposed another conventional dual-band PIFA to solve the aforementioned problem. This conventional dual-band PIFA includes a radiating element, a grounding element, a feeding element, and a parasitic element. The dual-band PIFA of U.S. Pat. No. 6,714,162 is operable in a low frequency band that may be set by adjusting a length of the radiating element, and a high frequency band that may be set by adjusting a length of the parasitic element, a coupling distance between the parasitic element and the radiating element, and a coupling distance between the parasitic element and the grounding element.

The conventional dual-band PIFA of U.S. Pat. No. 6,714,162 is disadvantageous in that the setting of the high frequency band thereof involves several adjustments. Moreover, the coupling distances between the parasitic element and the radiating element and between the parasitic element and the grounding element are difficult to control. As such, an impedance frequency and a bandwidth of this conventional dual-band PIFA cannot be accurately calculated.

### SUMMARY OF THE INVENTION

Therefore, the object of the present invention is to provide an antenna device that can overcome the aforesaid drawbacks of the prior art.

According to the present invention, an antenna device comprises a single-loop radiating element, a radiating arm, a feeding element, and a grounding element. The single-loop radiating element includes a loop that is operable within a first frequency band. The radiating arm extends from the loop of the single-loop radiating element, and is operable within a second frequency band different from the first frequency band. The feeding element is connected to the loop of the single-loop radiating element and the radiating arm. The grounding element is connected to the loop of the single-loop radiating element.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional dual-band planar inverted-F antenna;

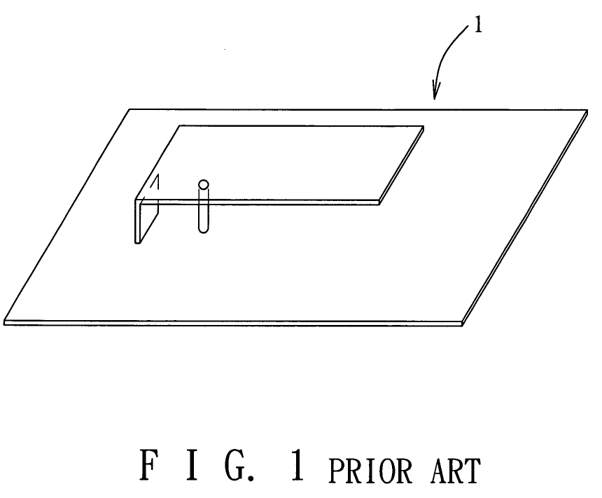

FIG. 2 is a perspective view of the first preferred embodiment of an antenna device according to the present invention;

FIG. 3 is a perspective view to illustrate an exemplary application in which the first preferred embodiment is installed in a notebook computer;

FIG. 4 is a schematic view to illustrate a state where the first preferred embodiment is flattened to extend along a plane;

FIG. 5 is a plot illustrating a voltage standing wave ratio (VSWR) of the first preferred embodiment;

FIG. 6 shows plots of radiation patterns of the first preferred embodiment respectively on the x-y, x-z, and y-z planes when operated at 2437 MHz;

FIG. 7 shows plots of radiation patterns of the first preferred embodiment respectively on the x-y, x-z, and y-z planes when operated at 5350 MHz; and

FIG. 8 is a perspective view of the second preferred embodiment of an antenna device according to the present invention.

### DETAILED DESCRIPTION OF THE PREFERRED EMBODIMENTS

Before the present invention is described in greater detail, it should be noted that like elements are denoted by the same reference numerals throughout the disclosure.

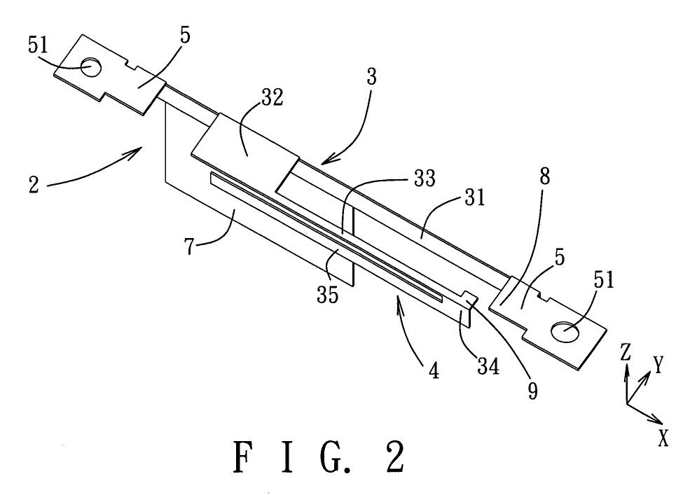

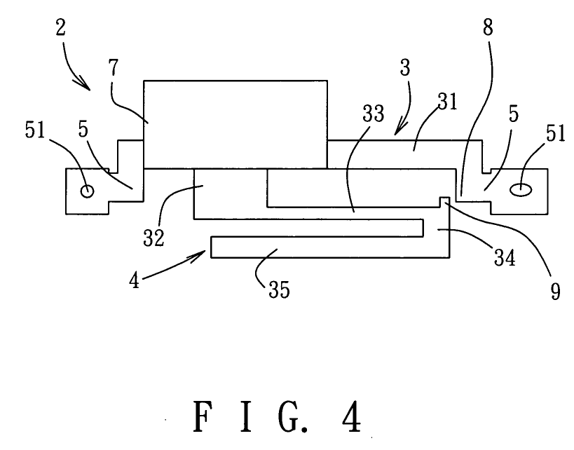

Referring to FIGS. 2 and 4, the first preferred embodiment of an antenna device 2 according to this invention is shown to include a single-loop radiating element 3, a radiating arm 4, a feeding element 9, and a grounding element 8.

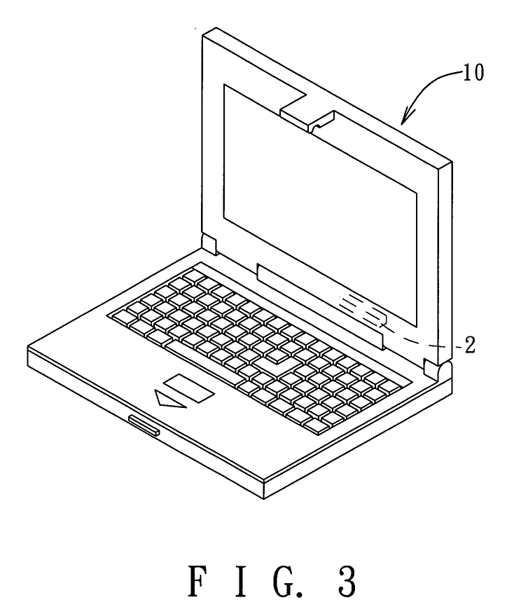

The antenna device 2 of this embodiment has a three-dimensional shape, and is mounted in a notebook computer 10, as illustrated in FIG. 3.

The single-loop radiating element 3 includes a loop that is operable within a first frequency band, i.e., 4900 MHz to 5875 MHz.

The radiating arm 4 extends from the loop of the single-lop radiating element 3 and is operable within a second frequency band, i.e., 2412 MHz to 2462 MHz.

The loop of the single-loop radiating element 3 includes first, second, and third sections 31, 32, 33. The first section 31 extends in a first direction (X), and has opposite first and second ends. The second section 32 extends in a second direction (Y) transverse to the first direction (X), and has opposite first and second ends. The first end of the second section 32 is connected to the first section 31 at a position between the first and second ends of the first section 31. The third section 33 extends in the first direction (X), and has opposite first and second ends. The first end of the third section 33 is connected to the second end of the second section 32.

The radiating arm 4 includes fourth and fifth sections 34, 35. The fourth section 34 extends in a third direction (Z) transverse to the first and second directions (X, Y), and has opposite first and second ends. The first end of the fourth section 34 is connected to the second end of the third section 33. The fifth section 35 extends in the first direction (X), and has opposite first and second ends. The first end of the fifth section 35 is connected to the second end of the fourth section 34.

It is noted herein that the first section 31 extends along a first plane. Moreover, each of the second and third sections 32, 33 extends along a second plane transverse to the first plane. Further, each of the fourth and fifth sections 34, 35 extends along a third plane parallel to the first plane.

The feeding element 9 is connected to the second end of the third section 33 of the single-loop radiating element 3 and a signal source (not shown) of the notebook computer 10.

The grounding element 8 is connected to second end of the first section 31 of the single-loop radiating element 3.

The antenna device 2 further includes a copper foil element 7 and a pair of securing members 5. The copper foil element 7 is connected to the first section 31 of the single-loop radiating element 3 and an electrical ground (not shown) of the notebook computer 10.

Each of the securing members 5 is formed with a hole 51 therethrough, and is connected to a respective one of the first and second ends of the first section 31 of the loop of the single-loop radiating element 3. As such, the antenna device 2 of this invention may be secured to the notebook computer 10 with the use of a pair of screws (not shown). That is, each of the screws is inserted through the hole 51 in a respective one of the securing members 5 and is engaged threadedly to the notebook computer 10.

In this embodiment, each of the feeding element 9 and the securing members 5 extends a long the second plane.

It is noted that the single-loop radiating element 3, the radiating arm 4, the feeding element 9, the grounding element 8, and the securing members 5 are made from a metal sheet.

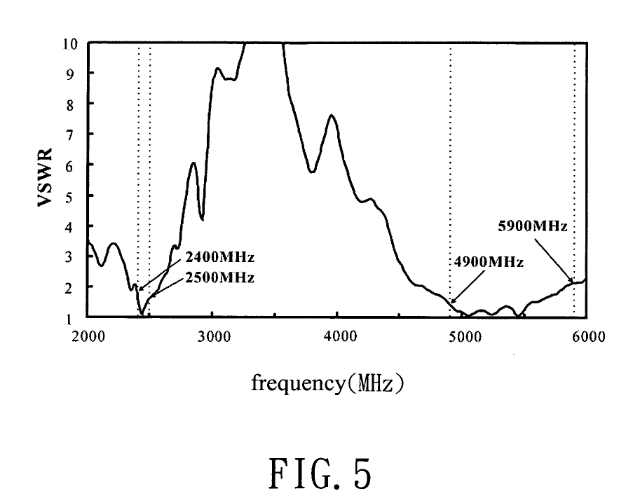

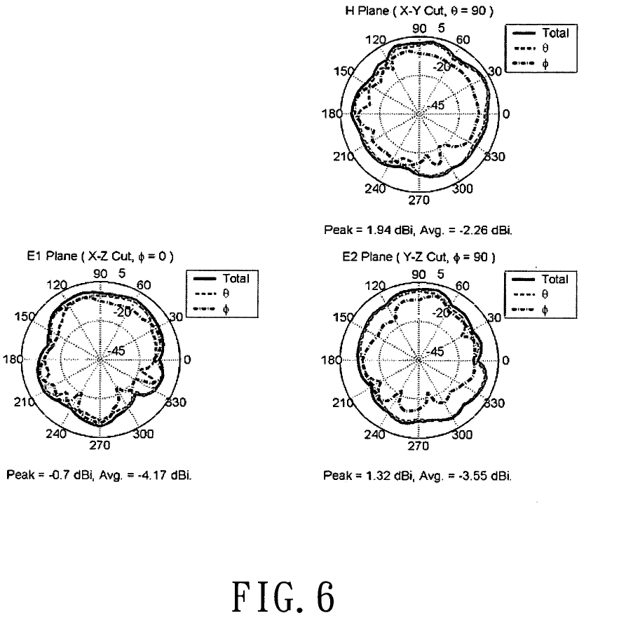

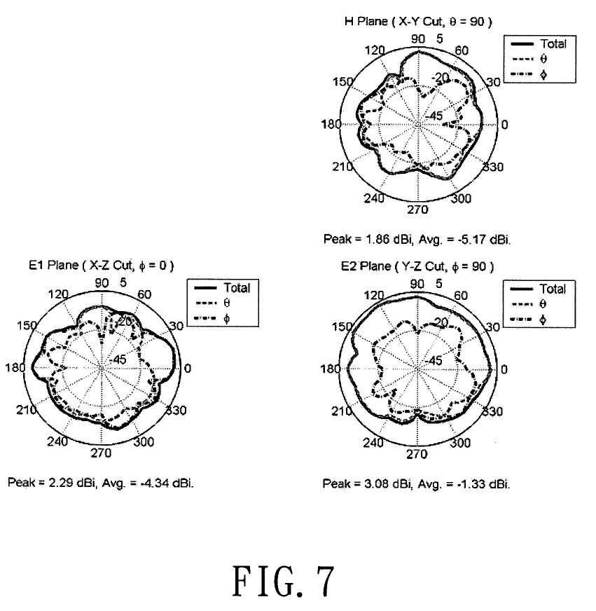

Experimental results, as illustrated in FIG. 5, shows that the antenna device 2 of this invention achieves a voltage standing wave ratio of less than 2.5 when operated within the first and second frequency bands. Moreover, as shown in Table I below, the antenna device 2 of this invention achieves satisfactory total radiation powers (TRP) and efficiencies when operated within the first and second frequency bands. Further, as illustrated in FIG. 6, the antenna device 2 of this invention has substantially omnidirectional radiation patterns when operated at 2437 MHz. In addition, as illustrated in FIG. 7, the antenna device 2 of this invention has substantially omnidirectional radiation patterns when operated at 5350 MHz.

TABLE I

| Frequency (MHz) | TRP (dBm) | Radiation Efficiency (%) |
|---|---|---|
| 2412 | −3.22 | 47.65 |
| 2437 | −2.70 | 53.69 |
| 2462 | −2.48 | 56.48 |
| 4900 | −3.70 | 42.62 |
| 5150 | −4.02 | 39.59 |
| 5350 | −4.10 | 38.93 |
| 5470 | −3.54 | 44.28 |
| 5725 | −3.98 | 39.98 |
| 5875 | −4.56 | 34.96 |

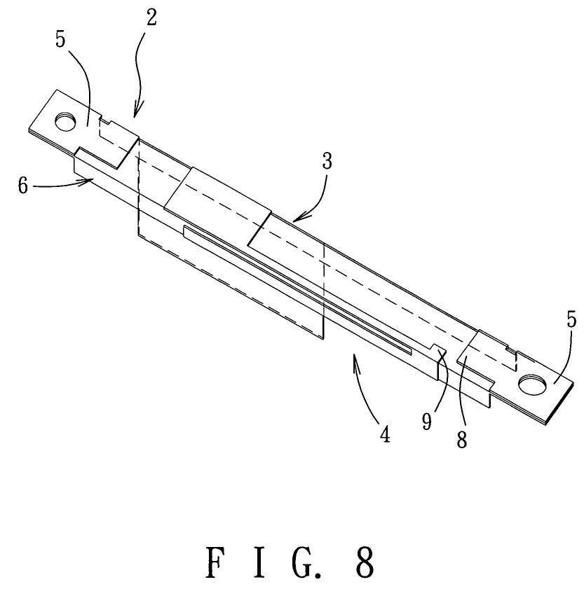

FIG. 8 illustrates the second preferred embodiment of an antenna device 2 according to this invention. When compared to the previous embodiment, the antenna device 2 of this embodiment further includes a dielectric substrate 6. The single-loop radiating element 3, the radiating arm 4, the feeding element 9, and the grounding element 8 are formed on the dielectric substrate 6. The construction as such prevents deformation of the antenna device 2 of this invention during installation thereof in the notebook computer 10.

It is noted that the loop of the single-loop radiating element 3, the radiating arm 4, the feeding element 9, the grounding element 8, and the securing members 5 are made from copper foil.

It has thus been shown that the antenna device 2 of this invention includes a single-loop radiating element 3, a radiating arm 4, a feeding element 9, and a grounding element 8. The single-loop radiating element 3 includes a loop is operable within the first frequency band. The radiating arm 4 extends from the loop of the single-loop radiating element 3 and is operable within the second frequency band. The feeding element 9 is connected to the loop of the single-loop radiating element 3 and the radiating arm 4. The grounding element 8 is connected to the loop of the single-loop radiating element 3. The construction as such simplifies the structure of the antenna device 2, permits easy adjustments of the first and second frequency bands and an impedance bandwidth of the antenna device 2, and widens a bandwidth of the antenna device 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An antenna device, comprising:
a single-loop radiating element including a loop that is operable within a first frequency band;
a radiating arm extending from said loop of said single-loop radiating element, and operable within a second frequency band different from the first frequency band;
a feeding element connected to said loop of said single-loop radiating element and said radiating arm; and
a grounding element connected to said loop of said single-loop radiating element.

2. The antenna device as claimed in claim 1, wherein said loop of said single-loop radiating element includes
a first section that extends in a first direction, and that has opposite first and second ends,
a second section that extends in a second direction transverse to the first direction, and that has opposite first and second ends, said first end of said second section being connected to said first section at a position between said first and second ends of said first section, and
a third section that extends in the first direction, and that has opposite first and second ends, said first end of said third section being connected to said second end of said second section.

3. The antenna device as claimed in claim 2, wherein said first section extends along a first plane, and each of said second and third sections extends along a second plane transverse to the first plane.

4. The antenna device as claimed in claim 3, wherein said radiating arm includes
a fourth section that extends in a third direction transverse to the first and second directions, and that has opposite first and second ends, said first end of said fourth section being connected to said second end of said third section, and
a fifth section that extends in the first direction, and that has opposite first and second ends, said first end of said fifth section being connected to said second end of said fourth section.

5. The antenna device as claimed in claim 4, wherein each of said fourth and fifth sections extends along a third plane parallel to the first plane.

6. The antenna device as claimed in claim 1, further comprising a copper foil element connected to said loop of said single-loop radiating element and adapted to be connected to an electrical ground.

7. The antenna device as claimed in claim 1, further comprising a securing member formed with a hole therethrough and connected to said loop of said single-loop radiating element.

8. The antenna device as claimed in claim 1, further comprising a dielectric substrate,
said single-loop radiating element, said radiating arm, said feeding element, and said grounding element being formed on said dielectric substrate.
